(19) United States
(12) Patent Application Publication
(10) Pub. No.: US 2015/0266652 A1
(43) Pub. Date: Sep. 24, 2015

(54) CONTAINERS WITH SHAPE-CHANGING MATERIALS

(71) Applicant: EMPIRE TECHNOLOGY DEVELOPMENT LLC, Wilmington (DE)

(72) Inventor: George Charles Peppou, Hornsby Heights (AU)

(21) Appl. No.: 14/435,324

(22) PCT Filed: Oct. 12, 2012
(86) PCT No.: PCT/US12/60022

§ 371 Date: Apr. 13, 2015

(51) Int. Cl. B65D 81/34; B65D 43/16; B29C 43/02; B65D 81/38

(52) U.S. Cl. CPC B65D 81/3446; B65D 81/3874; B65D 81/3886; B65D 43/16; B29C 43/021; B65D 2581/3471; B29K 2003/00; B29L 2031/7132

(57) ABSTRACT

Containers may be constructed with at least a portion of the container having a material which changes shape upon heating of the material. Containers may be constructed which are able to change shape, or expand, from a first configuration convenient for storage and shipping, to a second configuration convenient for the end user.

### BACKGROUND

In order to keep up with the pace of everyday activities, people in general are consuming more readily accessible foods and beverages, and are often carrying those foods and/or beverages with them as they go about their activities. An increasing variety of foods and beverages that are essentially ready for consumption are being sold at supermarkets and convenience stores. While some of these foods are edible off the shelf, others may require a simple heating process, such as can be achieved with a microwave oven. For additional convenience, these foods are often sold in cup or bowl-shaped containers which enable the products to be heated directly in the storage containers in which they are sold, and then be consumed directly from the container.

In order to enable containers with a hot product therein to be held, bulky insulation is generally disposed around the containers. Unfortunately, this added insulation takes up extra space, both on store shelves and in shipping containers. As a result, fewer products can be placed on a store shelf or in a shipping container, and packaging and shipping costs are increased.

Another packaging consideration for shipping involves the package shape. Ergonomic package shapes, while allowing packages to be more easily held or used, generally do not pack and store efficiently. Since containers may essentially only require the insulation to be present upon heating of the product and not during transport, it can be advantageous to minimize lost space due to insulation materials during transport. In addition, it can also be advantageous to package the products in containers that have shapes which minimize waste of space in transport and storage, but such shapes often may not be desirable or ergonomic for use during consumption.

There remains a need for packaging of foods and beverages that enables the best use of the available space in shipping containers and on storage shelves, while at the same time also providing for convenience for the end user.

### SUMMARY

Presently disclosed are container configurations that include a material which changes shape upon heating of the material. In various embodiments, the material may provide an increase in thickness to provide for an insulative layer, may change the shape or configuration of the container to vent or open the container, or may change the shape of the container from an efficiently packable container to an ergonomic user-friendly shape.

In an embodiment, a microwaveable container includes a base and at least one panel extending from the base, and the at least one panel and the base define an interior space. At least a portion of at least one of the at least one panel and the base comprises a material configured to change shape upon microwave heating.

In an additional embodiment, a container is provided for heating a substance therein. The container includes a base and at least one panel extending from the base, wherein the at least one panel and the base define an interior space for containing the substance therein. At least a portion of at least one of the base and the at least one panel comprises a heat expansible foam adapted to expand upon heating to provide an insulative surface.

In an embodiment, an insulative sleeve for a microwavable container is disclosed. The container has a base and at least one panel extending from the base and defines an external shaped configuration. The sleeve includes a first material layer defining an inner surface, a second material layer defining an outer surface, and a layer of heat expansible foam disposed between the first material layer and the second material layer.

In another embodiment, a method for manufacturing an insulating container for microwave heating of a food product therein includes preparing a heat expansible foam which includes a blowing agent, and forming at least a portion of a microwaveable container to include the foam, wherein the foam is expandable upon microwave heating to provide an insulative layer for the microwaveable container.

In an embodiment, a method of heating a food or beverage is disclosed. The method includes providing a container with a food or beverage disposed therein, wherein the container has a base and at least one panel extending from the base, with the at least one panel and the base defining an interior space for containing the food or beverage therein. At least a portion of at least one of the base and the at least one panel comprises a material adapted to change shape upon heating. The method also includes exposing the container to microwave energy to heat the food or beverage and change the shape of the material.

### BRIEF DESCRIPTION OF THE FIGURES

FIG. 1A depicts an expandable insulation layer on a cup-shaped container according to an embodiment.

FIG. 1B depicts an expandable sleeve for a cup-shaped container according to an embodiment.

FIG. 2 illustrates alternative methods for producing containers with expandable foam portions.

FIG. 3 depicts an illustrative example of the unfolding of a foam structure upon expansion of the foam according to an embodiment.

FIG. 4A depicts an unfolding container according to an embodiment.

FIG. 4B depicts an unfolding container according to an embodiment.

FIG. 5A depicts a container having a lid that opens upon expansion of a foam hinge element according to an embodiment.

FIG. 5B depicts a container having a vent that opens upon expansion of a foam hinge element according to an embodiment.

### DETAILED DESCRIPTION

Packaging containers, such as those used for containing, preparing and serving of food items, are generally configured for the convenience of the end user of the product, thereby making the containers more desirable for purchase. However, convenient packaging designs may not be efficient for storage and shipping. The present disclosure describes containers constructed from materials which are able to change shape, or expand, from a first configuration convenient for storage and shipping, to a second configuration convenient for the end user in order to satisfy all of these requirements.

One type of material which is able to provide such a change in shape is an expansible foam. Foam materials are able to provide insulation from hot and cold due to their randomly disposed air bubbles that slow the transfer of heat through the material. However, while the air content essentially does not provide added weight, foam materials are typically bulky which raises shipping costs because of the extra space taken up by the foam. In order to keep shipping costs low, but also provide insulation for the containers, foam materials that can be expanded at their destination when required by the end user would be desirable. For this purpose, foams may be formulated to include a residual amount of a liquid blowing agent (re-expansion agent) which is able to vaporize upon heating to expand the foam. When the foam is heated the volume of the foam may increase approximately three to ten times the original size. Boiling of the included liquid, which may be water or ethanol, for example, drives the expansion. One type of foam which may be configured to contain such a residual liquid is a starch acetate based foam.

A foam material may be provided as at least a part of a container for which it may be desirable to ship and store the container in a first configuration, while also having the container be convertible to a second configuration for the convenience of the user. One type of such container may be, for example, packaging for foods or beverages that are to be heated prior to ingestion. When at least a portion of the container includes an expandable foam and the foam is heated, the foam may expand to change a configuration of the

[symbol]

The foam may surround a polymer or paper barrier layer that is configured to contact and contain a product, such as, for example, a food product. Alternatively, the foam may be coated with such a barrier and be provided in the form of a sheet. The sheet may be formed into a container for containing the product therein. The package or container with un-expanded foam may then be shipped and stored in a reduced or compact size. When the end user is ready to use the product, such as when a consumer wishes to heat a food for consumption, the container and contents may be heated causing the foam to expand.

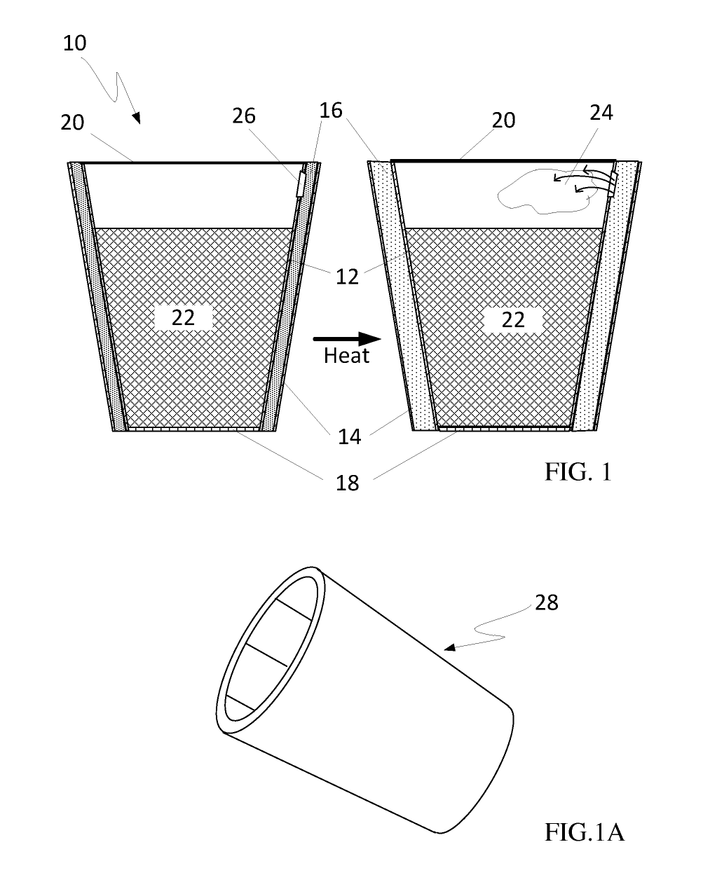

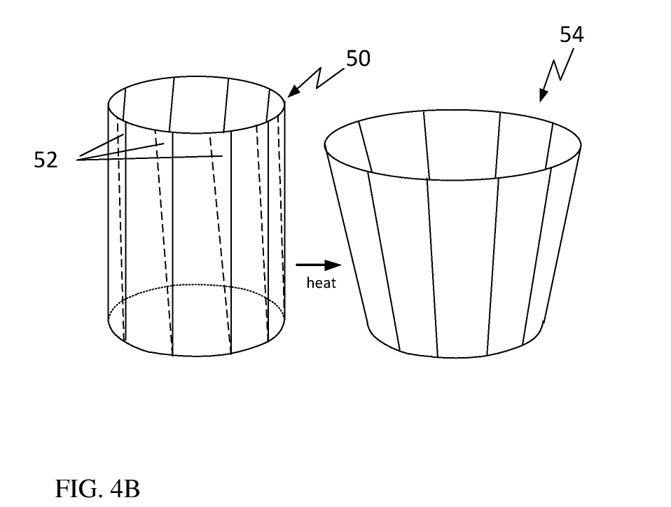

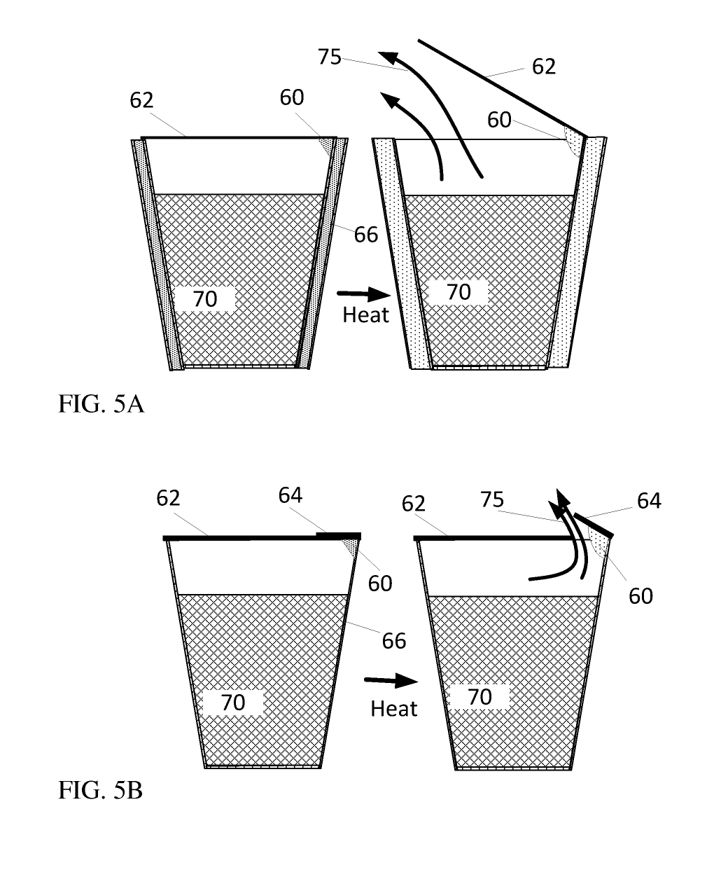

In an embodiment as depicted in FIG. 1A, an expansible foam may be used to provide an insulative layer around a container. In this configuration, the expanded foam may provide enhanced insulation which may be approximately comparable to the insulative properties of polystyrene. In additional embodiments, as depicted in FIGS. 4A, 4B, 5A and 5B, foam may be used on or in a container or package to change the shape of at least a portion of the package when heated. As an example, the foam may expand to push open a portion of the container to vent the container (FIGS. 5A and 5B), or the package may be configured as an articulating package (FIGS. 4A and 4B) that may automatically ‘unfurl’ when heated, expanding at least a portion of the packaging to a size greater than the original size. The materials used to provide such packaging may be low cost, safe, sustainable, biodegradable, and may provide a reliable method of altering packaging shape as part of existing consumer food preparation.

FIG. 1 depicts a cup-shaped container 10 with an expanding foam as an insulative layer. A container 10 may also have other configurations, such as a bowl-shaped configuration. Such a container 10, for example, may be disposable packaging used for storage and preparation of ready to eat microwavable meals or drinks, such as microwavable soup, and ready to eat rice and pasta. To enable the food product to be heated and then held by the consumer for consumption, the package may provide some degree of insulation to allow the heated contents to be safely handled by the consumer. While the descriptions herein are given in relation to the heating of food items, such containers may be configured for the heating of other materials and liquids, as well.

In an embodiment as depicted in FIG. 1, the container 10 may have a base 18 with at least one panel extending from the base to define a sidewall. The sidewall may have three layers: an inner, food containing barrier layer 12, an outer layer 14 carrying or providing a label, and an expanding foam layer 16 enclosed between the inner and outer layers. The base 18 may be solid to provide stability to the container, or alternatively, the base may be formed in a manner similar to the layered configuration of the sidewalls. The inner layer 12 may define an interior space for containing food contents 22, and may be formed of a polymer layer or waterproof waxed cardboard layer to contact the food and prevent contact of the food directly with the foam 16. The outer layer 14 may be formed of a printed label, which may be a biodegradable material, such as paper or a biopolymer. The overall packaging rigidity may be generated by any combination of the three layers. A lid 20 may be releasably sealed to the top of the container to retain the contents 22 within the container.

In an embodiment, the foam 16 may be a starch acetate foam which is steam permeable and may include water as the blowing agent. Steam 24 generated upon heating of the foam may be vented from the foam and into the container 10 through one of more vents 26 in the inner wall 12. By venting the steam 24 above the food product, the steam may contribute to the heating of the food, and the sight of the steam may be visually appealing to the consumer. In this configuration, the central foam region of the packaging exterior expands upon heating while the food is being heated, and the expanded foam can provide insulation, helping to maintain the internal temperature of the food while also providing a cool surface to hold on the external surface. By using a heat expandable material the package can ship with compressed insulation that only expand when required, thereby permitting the size of the container to be reduced and providing a sustainable, reliable and environmentally friendly method of creating insulated ready to eat meals.

As an alternative to forming the walls of a container of a foam material such as the embodiment of FIG. 1A, a cylindrical sleeve 28 such as that depicted in FIG. 1A could be formed from an expandable foam. Such a sleeve 28 may also have a three layer construction with inner and outer layers enclosing a layer of foam therebetween. Sleeves of this type may be manufactured in various sizes and configurations to fit around the exterior of food containers, which may be cup-shaped, for example. Such sleeves may be provided separately from the containers or in conjunction with the containers, and then be placed around the container prior to the heating of the container and any contents therein.

Several different types of foams may be used within the context of the embodiments. The foams may include starch foams, starch acetate foams, cellulose acetate foams, soy foams, sugar foams, lipid foams, protein foams, and polymer foams such as polystyrene, polypropylene, polyethylene, polyvinyl, polylactic acid, polyimide. In addition, the foam may be a derivative of any of these foams, or a combination of any of these foams. One type of foam which is relatively inexpensive, biodegradable, and generally safe to use in the presence of foods is a starch/starch acetate foam. A starch/starch acetate mixed foam can provide improved structure and stability in comparison to pure starch acetate foams. A foam may be formulated to include about 40% to about 50% native starch and about 50% to about 60% starch acetate.

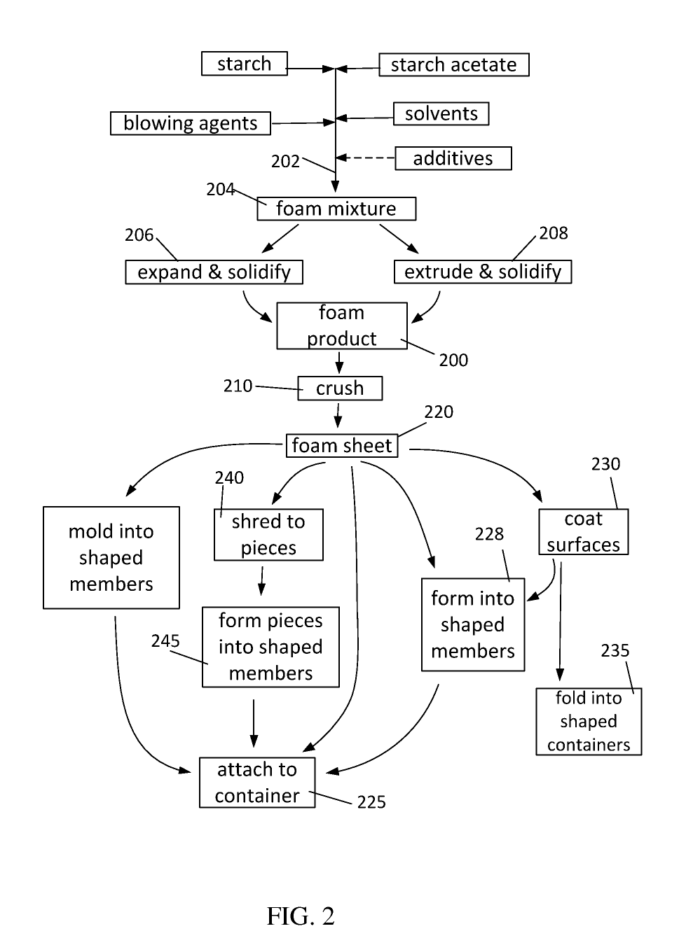

FIG. 2 illustrates several process steps which may be used for producing containers according to the various embodiments. A starch/starch acetate foam product 200 may be prepared by a combining at least starch, starch acetate and a blowing agent in a solvent to produce a solvated foam mixture 204. Some examples of solvents may include water, NMMO (N-Methylmorpholine N-Oxide), ethyl acetate, acetic acid, acetyl chloride, sodium hydroxide, and dimethyl sulfoxide. The ratio of solvent to starch/starch acetate may be from about 5:95 by weight to about 40:60 by weight. In addition, one or more additives may optionally be added to the solvated starch mixture to improve native foam properties depending on performance requirements.

One of the additives may include a plasticizer. Several starch foam plasticizers may be included to provide improved properties to the foam itself, including improving mechanical strength and reducing moisture absorbance properties. Some examples of plasticizers which may be used include glycerol, urea, ammonium chloride, polyvinyl alcohol, ethylene polyvinyl alcohol, and combinations thereof.

Another additive may include biopolymers which may improve mechanical properties, improve composting performance and improve barrier properties. Some examples of biopolymers include polylactic acid, biopolyester, cellulose acetate, nitrocellulose, celluloid, polyhydroxyalkanoate (PHA), polyhydroxybutyrate (PHB), polyhydroxyvalerate (PHV), polyhydroxyhexanoate (PHH), polyamide 11 (PA 11), poly(hydroxy ester ether) (PHEE), poly(3-hydroxy butyrate-co-3-hydroxyvalerate) (PHBV), biopolyethylene and combinations thereof. The inclusion of various biopolymers can provide for foams having slightly different properties including altered cell size and foam density.

Another foam additive which may be used to decrease expansion time during heating in a microwave oven may include microwave susceptors. Microwave susceptors can increase the temperature generated in the foam compared to the blowing agent alone by increasing localized heating, thereby reducing the amount of microwave energy needed to expand the foam. Some examples of microwave susceptors include flakes or particles of any of aluminum, metallized film, ceramic, ferrous oxide, tin oxide, graphite, carbon, copper, iron, zinc, nickel, magnesium, gold, silver, silicon, silicon carbide, ferrites and combinations thereof.

The blowing agent affects the expansion of the foam since lower boiling point agents will expand the foam more quickly upon heating than higher boiling agents. Examples of blowing agents may include alcohols, such as methyl alcohol, ethyl alcohol, propyl alcohol, butyl alcohol, hydrocarbons (including but not limited to: pentane, isopentane, cyclopentane), isocyanate, sodium bicarbonate, water and combinations thereof. For some containers, it may be desirable, or possibly necessary for the foam to expand slowly, while for other containers, it may be desirable, or possibly necessary for the foam to expand as quickly as possible. By selecting a blowing agent in tandem with altering the quantity of any susceptors in the foam to enhance the expansion rate, or possibly not using any susceptors in the foam to allow expansion to occur more slowly, foams may be ‘tuned’ to expand at varying rates.

For example, in one embodiment, the content of a container may only need to be heated for 1 minute in a conventional microwave on a high setting to bring the content to a desired temperature. The foam may be configured to contain an amount of a susceptor which, along with a formulation of a blowing agent, increases the energy received in the foam, enabling the foam to heat more quickly and be fully expanded at the end of the 1 minute microwave cycle. At a lower microwave setting for the same container, additional time would be required to fully heat the contents, and the proportion of susceptors in the foam would likewise receive less energy but still enable the foam to be fully expanded by the end of the heating cycle.

In another embodiment, the content of a container may need to be heated for about 3 minutes in a conventional microwave on a high setting. Since the foam on this container would therefore have additional time to reach its fullest expansion, the susceptors may be omitted, as three minutes may be sufficient time to expand the foam with only the blowing agent.

In another embodiment, since microwave power output may vary between different makes and models, a foam may be configured with appropriate amounts of susceptors in relation to the chosen blowing agent to expand at essentially the same rate at which the contents of a container are heated. Thus, when such a foam is fully expanded, a consumer would be able to recognize that the contents have achieved a desired temperature and turn off the microwave to end the heating cycle. In this way it may be possible to tune the foam to act as an indicator of food temperature, so that the amount of microwave energy required for expansion may be the same as the energy needed to heat the food within the package.

As an example, a starch/starch acetate foam without susceptors may attain a full expansion in about 90 seconds at a maximum setting in an 800 watt microwave. However, a food product may require only about 45 seconds to be heated in the same microwave. It may be possible that with susceptors, the same foam composition, but having approximately 10% by weight of aluminum flakes, may require only about 45 seconds to reach full expansion. This modified foam would therefore be preferred for the indicated food product so that full expansion would be attained for the appropriate heating period.

For preparation of the foam, depending on the foam formulation and the desired foam product, a foamable mixture may be allowed to expand and solidify 206, or may be extruded 208 into shaped configurations. For some foams, such as starch foams, as the foam is extruded the starch solvent boils, producing gas to generate the foam. In an embodiment, the foam may be dried, at least partially, in an oven to stabilize the foam for general usage. In an alternate embodiment, the foam may not be dried, thereby not removing any of the residual water or alcohol content that will remain in the foam to act as the blowing agent.

The cured foam 200 may be crushed 210 to force air/gases out of the foam to reduce the thickness of the foam to a desired thickness or to a minimal thickness to minimize the space occupied by the foam. The cell structure of the foam is essentially preserved when the foam is crushed thereby giving the foam the ability to be re-expanded when the blowing agent is vaporized. The crushed foam, which may be in the form of thin sheets 220, may be used for the formation of, and/or the application to containers.

In an embodiment, the sheets 220 may be cut and attached 225 to the exterior of containers without any further modification of the sheets. Alternatively, the foam sheet 220 may be formed into shaped members 228 prior to being attached to containers 225. However, to provide added durability and protection to the foam, and/or to isolate the foam from any products with which it may be in contact, at least one of the surfaces of the foam sheet 220 may be coated 230 with appropriate materials, such as a polymer layer, a paper layer, a waxed paper layer, or any other suitable surfacing material. Coated foam sheets may be formed 235 directly into shaped containers, or may be formed 228 into shaped members for being attached to containers 225. For example, sheets may be formed into cup-shaped cylindrical configurations, such as are represented in FIGS. 1A and 1B, or folded into box-shaped containers, as shown in FIG. 4A. Alternatively, in other embodiments, only a portion of a container may be formed from such sheets.

In other embodiments, the crushed foam sheet 220 may be shredded 240 into smaller pieces and reformed 245 into containers or members for being attached to containers 250, or rolled into a sheet at a low temperature to generate an essentially continuous piece of unexpanded foam. Such sheets may be fused with a barrier surface layer and processed into desired container configurations. Alternatively, a foam sheet 220 may be compression molded 250 into shaped members for being attached to containers 225.

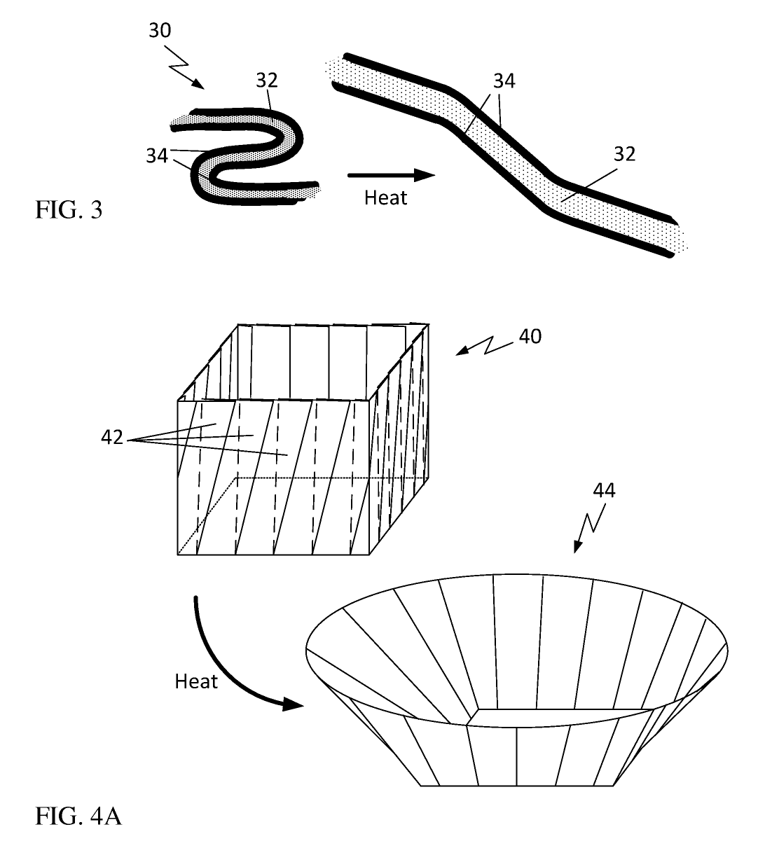

In addition to providing an external insulative layer, materials, such as the foams described previously, which change shape upon heating, may also be used to change the physical shape and size of a container. As shown in FIG. 3, a sheet 30 may be configured with an expansible material 32 layered between surface materials 34. When heated, the sheet 30 may unfurl or unfold as folds in the sheet are forced outwardly upon expansion of the inner material 32.

As shown in FIGS. 4A and 4B, this type of unfolding may be used for changing the shape of a container 40 or 50. Packages containing foods that may be eaten directly from the package may often be generally bowl-shaped. Such bowl-shaped packages pack poorly, leaving large amounts of empty space between packages when they are stacked on shelves or packed into secondary packages for shipping. However, by providing a shape-changing package that incorporates a shape changing material, the empty space between packages may be significantly reduced, while also reducing the size of the container.

Cuboid shaped packages 40 are able to be packed face-to-face adjacent one another, but would be more difficult to eat from than a bowl shaped package. A sheet material such as a sheet 30 (FIG. 3) may be folded to have folded pleats 42 with a greater fold overlap at the top of the container than at the bottom where there may essentially be little to no overlap. The perimeter at the top may be the same as the perimeter at the bottom. The package 40 would unfold upon heating so that the perimeter at the top would increase to produce a bowl 44 of a frusto-pyramidal shape and having a volume which is greater than the original volume of the container. In addition, when the shape changing material is a foam as discussed previously, the expanded foam in the sidewalls and possibly the base of the unfolded bowl would also provide an insulative layer to help retain heat in the bowl interior and also allow the bowl to be picked up and held. Additionally, as described above, the expansion may be ‘tuned’ so it occurs once the food has reached an appropriate temperature. This would allow the unfurling of the package to indicate that the food was ready for consumption.

In a similar manner, a sheet 30 (FIG. 3) may be folded to form cylindrical containers 50 as shown in FIG. 4B, with folded pleats 52 having a greater fold overlap at the top of the container than at the bottom where there may be little to no overlap. While such cylinders would not pack as efficiently as the cuboids, they would still retain a packaging efficiency which was greater than that of bowl shaped containers. Upon heating of the cylinders 50, the pleats 52 would unfold to form a bowl 54 of a frusto-conical shape.

While not shown in the drawings, containers 40 and 50 may be provided with lids or covers which would prevent spillage and/or contamination of the contents during shipping and storage. Any provided lids or covers may be removable prior to heating to permit unhindered unfolding of the pleats. One example of a cover may be a foil or plastic cover adhesively adhered about the perimeter of the open upper end of the container. Such a lid would be configured to be peeled off prior to heating. Another lid configuration may have a cardboard profile to match the shape of the upper end of the container. An additional lid type may be configured as discussed herebelow with reference to FIG. 5A.

As shown in FIGS. 5A and 5B, a material which changes shape upon heating may also be configured as a hinge-type element that is configured to push open a lid 62 or vent 64. In an embodiment, a spot of expandable foam 60 may be positioned at the juncture of the lid 62 or vent 64 and a wall portion 66 of the container. As the container is heated, the foam 60 will expand and force open the lid or vent, releasing steam 75 from within the container. By having the lid 62 or vent 64 open during the heating process, a steam build-up within the container may be prevented, thus reducing the risks of the consumer being burned by steam during removal of the cover.

The opening of lid 62 or vent 64 may also be used as an indicator to show that food within the container has achieved a satisfactory temperature. As previously discussed, the foam may be tuned to open at a point when the food has reached a satisfactory temperature. Thus, during heating, the lid may intentionally be left in place to allow steam to gather in the headspace to enhance heating of the food, and when a predetermined temperature has been reached and foam expansion occurs, the lid 62 or vent 64 may be pushed open. This opening of the lid 62 or vent 64 may therefore indicate that the contents have been satisfactorily heated.

Various features as presented above and described with respect to the embodiments as presented in FIGS. 1-5B may be provided, either singly, or in combination with others of the features, so that a container may include any or all of the features as presented herein.

A container prepared according to any of the above embodiments, such as container 10 of FIG. 1, or container 40 of FIG. 4A may be used for delivering prepared food items to consumers, and the containers may be conveniently heated in a microwave for a quick meal. A prepared food, such as a pasta meal, may be provided in an expandable container 40 such as that of FIG. 4A. A consumer, when ready to eat the food item, may remove a lid from the container and place the container of food in a microwave oven. The food may be for the recommended period of time, or to an extent at which the consumer prefers. The foam in the walls of the cuboid shaped container may be configured to expand essentially simultaneously with the heating to form a bowl-shaped container 44 having a rectangular bottom and a somewhat circular top from heat expanded pleats. The expanded foam in the walls and sides will provide an insulative side walls to help retain heat within the food while allowing the consumer to handle the container in spite of the heat of the food item.

### EXAMPLES

### Example 1

### Production of an Expandable Foam

An expandable foam with water as the blowing agent may be prepared to have about 46% native starch and about 54% starch acetate. About 46 g of native starch and 54 g of starch acetate may be combined and mixed with about 50 ml of water as a solvent to produce a foamable mixture. In addition, up to 30 ml of water may be added so that the foam has about 30 wt % water as the blowing agent.

The resultant foamable mixture may be extracted into foam strips with a twin-screw mixing extruder at a screw speed of about 163 revolutions per minute and a temperature of about 148° C. After allowing the foam to cure, the foam may be pressed with a roller to reduce the thickness of the foam to about 3 mm. The upper surface may then be coated with a thin polymer sheet to produce a finished expandable foam product.

### Example 2

### Insulative Sleeve

A patterned die may be used to cut the prepared sheets of Example 1 into patterned portions of a shape for forming cup-shaped cylindrical sleeves. An adhesive may be applied to one or both of the edges, and the patterned piece rolled on a mandrel to join the ends and form a sleeve. After the adhesive has set, the sleeve may be folded into a planar configuration. Such sleeves may then be stacked, packaged and sold. A sleeve may be inserted over a cup just prior to heating the cup and its contents.

### Example 3

### Sleeve Insulated Cups

As in Example 2, a patterned die may be used to cut the prepared sheets of Example 1 into patterned portions of a shape for forming cup-shaped cylindrical sleeves. An adhesive may be applied to one or both of the edges, and the patterned piece rolled on a mandrel to join the ends and form a sleeve. The formed sleeves may be directly adhered to cup-shaped containers which will be filled with a heat and eat food item. Once filled, containers may be packaged and sold with sleeves attached.

### Example 4

### Formed Insulated Cups for Microwavable Foods

A sheet of wax-coated cardboard may be attached to the second side of the sheet of Example 1. A patterned die may be used to cut the prepared sheets into patterned portions of a shape for forming a cup-shaped container. An adhesive may be applied to one or both of the edges, and the patterned piece rolled on a mandrel to join the ends and form a cylindrical cup-shaped panel with the cardboard disposed internally within the panel.

A circular base may also be die cut from a wax-coated cardboard. Adhesive may be applied about the perimeter of the base and the base attached to the bottom of the sleeve to form an insulated cup.

### Example 5

### A Shape-Changeable Container

A sheet of wax-coated cardboard may be attached to the second side of the sheet of Example 1. A patterned die may be used to cut the prepared sheets into patterned portions of a shape which will produce a folded container. The die-cut shaped pattern may be folded in a folding machine to pleat the sides and form a cuboidal shaped container.

### Example 6

### Heating a Ready-to-Eat Food in an Expandable Container

A prepared food, such as a pasta meal, may be purchased in an expandable container such as that of Example 4. A consumer, when ready to eat the food item, may place the container of food in a microwave oven and heat the food for the recommended period of The foam in the walls and base of the cuboid shaped container will expand essentially simultaneously with the heating to form a bowl-shaped container having a rectangular bottom and a somewhat circular top from the expanded pleats. The expanded foam in the walls and sides will provide an insulative layer around the bowl and insulated side walls to help retain heat within the food while allowing the consumer to handle the container in spite of the heat of the food item.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A microwaveable container comprising:
a base; and
at least one panel extending from the base,
wherein the at least one panel and the base define an interior space, and
wherein at least a portion of the at least one panel or the base comprises a material configured to change shape upon microwave heating.

2. The container of claim 1, wherein the interior space defines a volume prior to heating, and the material is configured to change shape to increase the volume upon microwave heating.

3. The container of claim 1, wherein the container has a shape prior to heating and the material is configured to alter the shape of the container upon microwave heating.

4. The container of claim 1, wherein the material comprises a heat expansible foam configured to expand upon microwave heating, wherein the heat expansible foam is selected from the group consisting of at least one of starch foams, starch acetate foams, cellulose acetate foams, soy foams, sugar foams, lipid foams, protein foams, and a polymer foam and derivatives thereof, and combinations thereof.

5-6. (canceled)

7. The container of claim 4, wherein the heat expansible foam comprises the starch acetate foam comprising about 40 weight percent to about 50 weight percent native starch, and about 50 weight percent to about 60 weight percent starch acetate.

8. (canceled)

9. The container of claim 1, wherein:
the material comprises a heat expansible foam comprising:
at least one additive for improving at least one mechanical property of the foam, and
a blowing agent for expanding the foam upon heating.

10. (canceled)

11. The container of claim 9, wherein the at least one additive comprises at least one of:
a plasticizer selected from the group consisting of glycerol, urea, ammonium chloride, polyvinyl alcohol, ethylene polyvinyl alcohol, and combinations thereof;
a biopolymer selected from the group consisting of polylactic acid, biopolyester, cellulose acetate, nitrocellulose, celluloid, polyhydroxyalkanoate, polyhydroxybutyrate, polyhydroxyvalerate, polyhydroxyhexanoate, polyamide 11, poly(hydroxy ester ether), poly(3-hydroxy butyrate-co-3-hydroxyvalerate), biopolyethylene and combinations thereof; and
a microwave susceptor comprising flakes or particles selected from the group consisting of aluminum, metallized films, ceramics, ferrous oxide, tin oxide, graphite, carbon, copper, iron, zinc, nickel, magnesium, gold, silver, silicon, silicon carbide, ferrites and combinations thereof.

12. The container of claim 9, wherein the blowing agent comprises water, methyl alcohol, ethyl alcohol, propyl alcohol, butyl alcohol, pentane, isopentane, cyclopentane, isocyanate, or sodium bicarbonate, or combinations thereof.

13-18. (canceled)

19. The container of claim 1, wherein the material comprises a heat expansible foam, the at least one panel comprises a first material layer defining an inner surface, a second material layer defining an outer surface, and a layer of the heat expansible foam disposed between the first material layer and the second material layer.

20. The container of claim 1, wherein:
the at least one panel has a proximal portion attached to the base and a distal portion disposed away from the base;
the distal portion defines a perimeter; and
the at least one panel comprises pleats extending in a direction from the proximal portion to the distal portion, the pleats being configured to unfold upon expansion of the foam between the first and second layers to increase the perimeter at the distal portion.

21-28. (canceled)

29. The container of claim 1, further comprising:
a cover hinged to the at least one panel by at least one hinge device,
wherein the material comprises a heat expansible foam disposed on the at least one panel adjacent at least one hinge device for pushing open the corresponding cover upon expansion of the foam by microwave heating.

30-42. (canceled)

43. An insulative sleeve for a microwavable container, the container having a base and at least one panel extending from the base and defining an external shaped configuration, wherein the sleeve comprises:
a first material layer defining an inner surface;
a second material layer defining an outer surface; and
a layer of heat expansible foam disposed between the first material layer and the second material layer.

44. (canceled)

45. The sleeve of claim 43, wherein the sleeve is configured to be placed around the microwaveable container prior to microwave heating, and the sleeve is configured to form an expanded insulative layer around the microwaveable container upon microwave heating.

46. The sleeve of claim 43, wherein the heat expansible foam comprises a blowing agent for expanding the foam upon microwave heating, wherein the blowing agent is selected from the group consisting of water, methyl alcohol, ethyl alcohol, propyl alcohol, butyl alcohol, pentane, isopentane, cyclopentane, isocyanate, or sodium bicarbonate, and combinations thereof.

47. (canceled)

48. The sleeve of claim 43, wherein the heat expansible foam comprises a crushed starch acetate foam comprising:
at least one additive for improving at least one mechanical property of the foam; and
a blowing agent for expanding the foam upon heating with microwaves.

49. The sleeve of claim 48, wherein the at least one additive comprises at least one of:
a plasticizer selected from the group consisting of: glycerol, urea, ammonium chloride, polyvinyl alcohol, ethylene polyvinyl alcohol, and combinations thereof;
a biopolymer selected from the group consisting of: polylactic acid, biopolyester, cellulose acetate, nitrocellulose, celluloid, polyhydroxyalkanoate, polyhydroxybutyrate, polyhydroxyvalerate, polyhydroxyhexanoate, polyamide 11, poly(hydroxy ester ether), poly(3-hydroxy butyrate-co-3-hydroxyvalerate), biopolyethylene and combinations thereof; and
a microwave susceptor comprising flakes or particles from the group consisting of: aluminum, metallized films, ceramics, ferrous oxide, tin oxide, graphite, carbon, copper, iron, zinc, nickel, magnesium, gold, silver, silicon, silicon carbide, ferrites and combinations thereof.

50-76. (canceled)

77. A method of making a heat expansible foam, the method comprising:
mixing starch, starch acetate, a blowing agent and an additive to form a foamable mixture;
extruding the foamable mixture to form a foam; and
crushing the foam to form the heat expansible foam.

78. The method of claim 77, wherein mixing comprises mixing starch, starch acetate, the blowing agent and the additive to form the foamable mixture wherein the foamable mixture comprises native starch in about 40 weight percent to about 50 weight percent, and starch acetate in about 50 weight percent to about 60 weight percent.

79. The method of claim 77, wherein mixing comprises mixing starch, starch acetate, the additive with the blowing agent selected from the group consisting of water, methyl alcohol, ethyl alcohol, propyl alcohol, butyl alcohol, pentane, isopentane, cyclopentane, isocyanate, and sodium bicarbonate, and combinations thereof.

80. The method of claim 77, wherein mixing comprises mixing starch, starch acetate, the blowing agent and the additive selected from at least one of:
a plasticizer selected from the group consisting of: glycerol, urea, ammonium chloride, polyvinyl alcohol, ethylene polyvinyl alcohol, and combinations thereof;
a biopolymer selected from the group consisting of: polylactic acid, biopolyester, cellulose acetate, nitrocellulose, celluloid, polyhydroxyalkanoate, polyhydroxybutyrate, polyhydroxyvalerate, polyhydroxyhexanoate, polyamide 11, poly(hydroxy ester ether), poly(3-hydroxy butyrate-co-3-hydroxyvalerate), biopolyethylene and combinations thereof; and
a microwave susceptor comprising flakes or particles from the group consisting of: aluminum, metallized films, ceramics, ferrous oxide, tin oxide, graphite, carbon, copper, iron, zinc, nickel, magnesium, gold, silver, silicon, silicon carbide, ferrites and combinations thereof.

81. The method of claim 77, wherein extruding the foamable mixture comprises extruding at a screw speed of about 153 revolutions per minute to about 173 revolutions per minute and a temperature of about 138° C. to about 158° C.

82. The method of claim 77, wherein crushing the foam comprises crushing the foam without drying to form the heat expansible foam.

83. The method of claim 77, wherein crushing the foam comprises crushing the foam to form the heat expansible foam wherein the heat expansible foam comprises a substantial amount of the blowing agent.

84. The method of claim 77, further comprising molding the heat expansible foam to form a microwaveable container.
